(19) United States
(12) Patent Application Publication
(10) Pub. No.: US 2010/0224257 A1
(43) Pub. Date: Sep. 9, 2010

(54) REDUCING FOAM FORMATION

(76) Inventors: Kalman Shamir, Herzlia (IL); Moshe Marom, Kfar Saba (IL)

Correspondence Address: Amelia A. Buharin;Patent Legal Staff, Eastman Kodak Company, 343 State Street, Rochester, NY, 14650-2201, US

(21) Appl. No.: 12/400,010

(22) Filed: Mar. 9, 2009

(51) Int. Cl. F17D 1/00

(52) U.S. Cl. 137/2

(57) ABSTRACT

An apparatus for reducing foam formation of a developer liquid (19) in a plate processor device includes: means for pumping the developer liquid (19) into a developer liquid reservoir (17); and means for splitting (21, 22) the flow of the developer liquid (19) into the developer liquid reservoir (17) by filling the liquid reservoir through a first reservoir opening (14) and through a second reservoir (27) opening in parallel.

### FIELD OF THE INVENTION

The present invention relates to an apparatus and method for reducing foam formation thus reducing oxidation of the developer liquid, inside the plate developing machinery for the printing industry.

### BACKGROUND OF THE INVENTION

During the filling of the developer liquid into the developer tank of a plate developer device, penetrated air often causes foam formation of the developer liquid. The generated foam, due to its large surface area increases the contact of developer liquid with the air in the system, and thus intensifies the chemical oxidation of the developer liquid. The above reaction results in degraded performance of the plate developing process.

The intention of this invention is to prevent, or at least substantially reduce, the foam formation of the developer liquid inside the plate developing machinery for lithographic digital printing plates.

### SUMMARY OF THE INVENTION

Briefly, according to one aspect of the present invention an apparatus for reducing foam formation in a plate processor device is presented. The apparatus includes pumping means to pump the developer liquid into a developer liquid reservoir, splitting means for splitting the flow of developer liquid into the developer liquid reservoir by filling the developer liquid reservoir through a first reservoir opening and through a second reservoir opening in parallel.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic illustrating a prior art developer liquid circulation and filling system in a plate developer system; and

FIG. 2 is a schematic illustrating developer liquid circulation and filling system in a plate developer system, which reduces substantially the foam formation caused during the filling of the developer liquid into the developer liquid reservoir.

### DETAILED DESCRIPTION OF THE INVENTION

The present invention describes a developer liquid circulation system in a plate developer system, which reduces substantially the foam formation caused during the filing of the developer liquid into the developer liquid reservoir. The created foam due its inherent large surface area exposed to air contact, increases the oxidation process of the developer liquid.

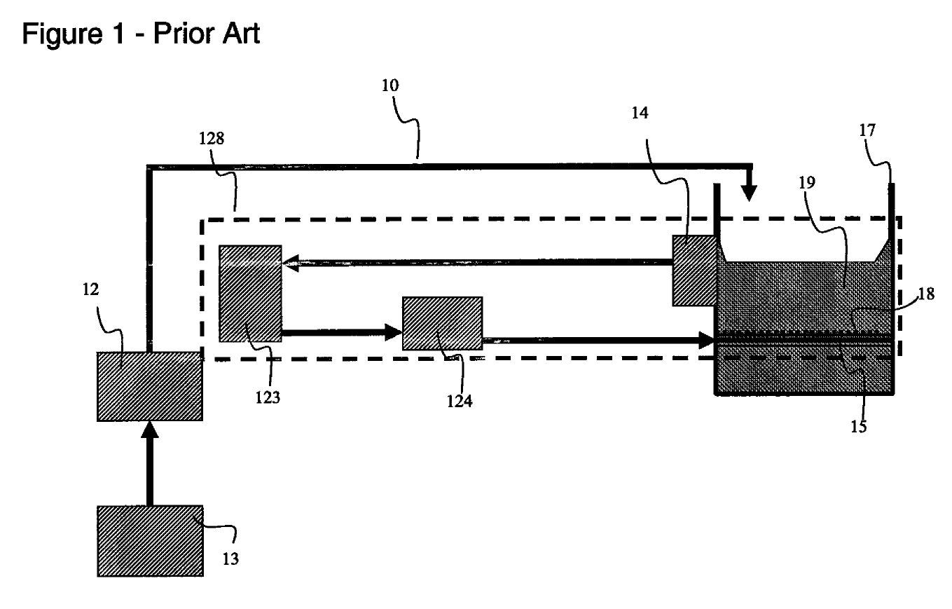

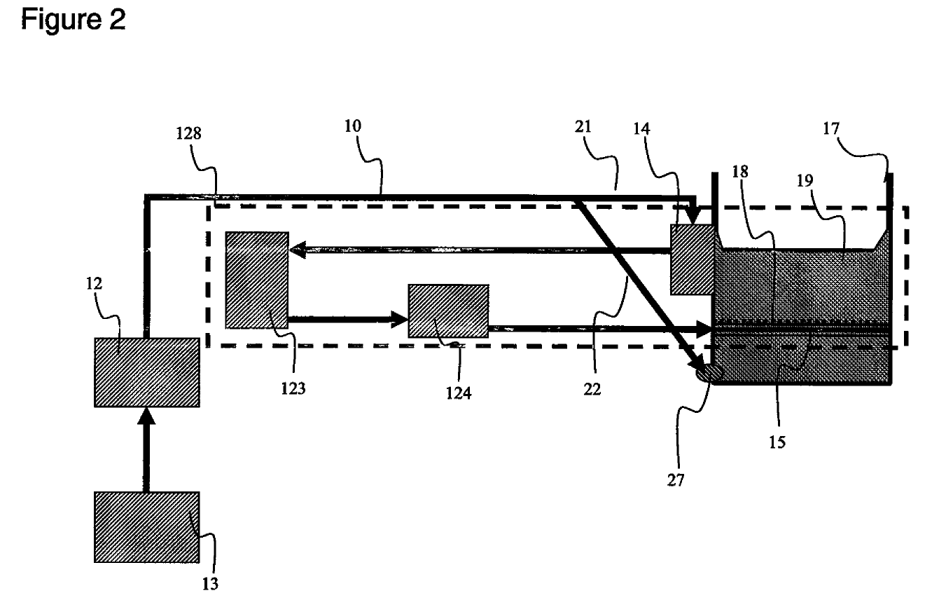

FIG. 1 shows a prior art developer circulation and filling system. FIG. 2 shows the essence of the proposed invention improving the developer circulation and filling system causing reduction of foam formation. The filling pump 12 pumps the developer liquid from the developer source reservoir 13 via main filling pipeline 10 into the developer liquid reservoir 17.

Main filling pipeline 10 is split into two pipeline sections. The first pipeline section 21 is used to flow the developer liquid into the circulation system 128. The circulation system comprises a developer circulation inlet 14, a circulation pump 123, a filter 124, and a spray bar 15. The developer circulation pump 123 pumps the developer liquid 19 from developer liquid reservoir 17 via developer circulation inlet 14 into the circulation system 128 in order to purify the developer by passing it through filter 124 and back into the developer liquid reservoir 17.

The spray bar 15 is positioned in the developer liquid reservoir 17, and is equipped with plurality of spray bar openings 18, for letting the developer liquid 19 to flow into the developer liquid reservoir 17.

During the filling of developer the pressure is being applied by filling pump 12 on the liquid that flows through the circulation system 128 via first pipeline section 21 to fill the developer liquid reservoir 17 with developer liquid 19. The applied pressure helps to get rid of the trapped air inside the circulation system 128, thus reducing the likelihood of foam formation causing oxidation of the developer liquid by the air.

In parallel to the described liquid flow via the first pipeline section 21, additional developer liquid flows via the second pipeline section 22. This liquid will also fill the developer liquid reservoir 17 with developer liquid 19, through a bottom opening 27 in the developer liquid reservoir 17.

This method reduces the foam formation by causing the flow of developer liquid to enter the developer liquid reservoir 17 through two distinct openings. First opening is through the circulation system 128 via the spray bar openings 18, which are situated inside the developer liquid reservoir 17. The second opening is the bottom opening 27 in developer liquid reservoir 17 additionally using a V shaped developer liquid reservoir 17 coupled with a bottom opening 27 will further minimize foam formation and air contact with the developer liquid.

The usage of two distinct openings to fill developer liquid 19 into developer liquid reservoir 17 will thus, minimize foam formation and the air contact with the developer liquid; hence oxidation of developer liquid is reduced.

The invention has been described in detail with particular reference to certain preferred embodiments thereof, but it will be understood that variations and modifications can be effected within the scope of the invention.

### PARTS LIST

10 main filling pipeline
12 filing pump
13 developer source reservoir
14 developer circulation inlet
15 spray bar
17 developer liquid reservoir
18 spray bar openings
19 developer liquid
21 first pipeline section
22 second pipeline section
27 bottom opening
123 circulation pump
124 filter
128 circulation system

1. An apparatus for reducing foam formation of a developer liquid in a plate processor device comprising:
pumping means to pump said developer liquid into a developer liquid reservoir, and
splitting means configured to split flow of said developer liquid into said developer liquid reservoir wherein said developer liquid reservoir is filled through a first reservoir opening and a second reservoir opening in parallel.

2. The apparatus of claim 1 wherein said splitting means comprising at least two filling sections wherein each of said filling sections is configured to supply said developer liquid into said developer liquid reservoir.

3. The apparatus of claim 1 wherein said first reservoir opening is a circulation system inlet.

4. The apparatus of claim 1 wherein said second reservoir opening is located at the bottom of said developer liquid reservoir.

5. The apparatus of claim 1 wherein said developer liquid reservoir is narrower in the bottom than in its top.

6. A method for reducing foam formation of a developer liquid in a plate processor, the method comprising:
pumping said developer liquid into a developer liquid reservoir; and
filling a developer liquid reservoir with said developer liquid wherein a first portion of said developer liquid is filled through a first reservoir opening into said developer liquid reservoir and a second portion of said developer liquid is filled through a second reservoir opening into said developer liquid reservoir, wherein filling of said liquid into said reservoir through said first opening and through said second opening is performed in parallel.

7. An apparatus for reducing foam formation of a developer liquid in a plate processor comprising:
a pump to pump said developer liquid into a developer liquid reservoir through a pipeline; and
a first fill line connected to said pipeline and to a first reservoir opening;
wherein said pipeline is connected to a second reservoir opening; and
wherein said developer liquid reservoir is filled through said first and second openings.
